(19) United States
(12) Patent Application Publication
(10) Pub. No.: US 2005/0225267 A1
(43) Pub. Date: Oct. 13, 2005

(54) Control circuit and method for controlling an electrical signal over a load such as a deflection cicruit of a cathode ray tube

(75) Inventors: Johannes Verhees, Eindhoven (NL); Hendrikus Groot Hulze, Eindhoven (NL); Vedran Kovacevic, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPJ ELECTRONICS N.V., EINDHOVEN, THE NETHERLANDS 5621 (NL)

(21) Appl. No.: 10/518,178

(22) PCT Filed: May 27, 2003
(86) PCT No.: PCT/IB03/02332

§ 371 Date: Dec. 15, 2004

(30) Foreign Application Priority Data
Jun. 18, 2002 (EP) 02077408.9

(51) Int. Cl. G09G 1/04

(52) U.S. Cl. 315/364

(57) ABSTRACT

The invention relates to a control circuit (2) for controlling an electrical signal (4) over a load (6) such as a deflection circuit of a Cathode Ray Tube, comprising a first transistor (8) for switching the electrical signal (4) over the load (6), wherein the load (6) is coupled to a collector (10) and an emitter (12) of the first transistor (8), and wherein the control circuit (2) also comprises a resonance circuit (14) which is coupled to a basis (16) and the emitter (12) of the first transistor (8) for driving the first transistor (8), a power supply (18) which is coupled to the resonance circuit (14) for driving the resonance circuit (14), a pulse generating circuit (20) which is coupled to the power supply (18) and the resonance circuit (14), and a processing unit (24) with a memory unit (26). Furthermore the invention relates to a method for adjusting a control circuit according to the invention.

The invention relates to a control circuit for controlling an electrical signal over a load such as a deflection circuit of a Cathode Ray Tube, comprising a first transistor for switching the electrical signal over the load, wherein the load is coupled to a collector and an emitter of the first transistor, and wherein the control circuit also comprises a resonance circuit which is coupled to a basis and the emitter of the first transistor for driving the first transistor, a power supply which is coupled to the resonance circuit for driving the resonance circuit, a pulse generating circuit which is coupled to the power supply and the resonance circuit, and a processing unit with a memory unit.

Furthermore, the invention relates to a method for adjusting a control circuit for controlling an electrical signal over a load according to the invention.

The said control circuit is known in practice. In the known control circuit the load is a deflection circuit for an inductive load like a deflection coil of a Cathode Ray Tube (CRT). The first transistor of the known control circuit is a bipolar switching transistor which is suited for switching large electrical currents through the deflection coil of the CRT. These large currents have to be switched off at regular time intervals, namely at the end of each line depicted on the screen of the CRT. Switching off of the currents takes place by drawing current from the base of the first transistor by supplying a zero or negative voltage to the base of the first transistor. As will be explained later on, this switching requires a lot of attention for which special switching circuitry has been developed.

If the first transistor is conducting, then an electrical current flows through its collector and emitter, wherein an electrical base-current is fed to its base. If the base-current is larger than corresponding with the gain factor of the first transistor, then an excessive number of charged particles will collect in the base of the first transistor. This is called “over-steering”. As a consequence, a relatively long time period is needed to remove all charge from the base region and hence reduce the collector current to zero. This will result in a relatively large heat dissipation of the first transistor during switching.

When the base-current of the first transistor is very small, then the voltage drop over the collector and emitter of the first transistor can be significantly larger than zero. This is called “under-steering”. In this situation, even with a relatively small electrical current through the collector and emitter of the first transistor, an excessive quantity of heat dissipation in the first transistor will take place.

Thus, both with “over-steering” and “under-steering” the first transistor will have a relatively large energy consumption level. Consequently, the first transistor will be heated in a short time and can even be damaged in an early stage.

In the known control circuit for controlling an electrical signal over a load a first transistor of a special kind is applied which can bear large voltages over and large currents through the collector and emitter. An important aspect is that this kind of transistor can be produced for reasonable production costs. A disadvantage of these transistors is that they usually have a low current gain and that the gain factor varies largely with different production samples. This, and also a wide spread of relevant control parameters of other components of the control circuit, result in that it is hardly possible to realise an optimal drive for the first transistor. As a consequence only a small amount of all produced control circuits of a series production of control circuits can drive the first transistor in an optimal way with a minimal heat dissipation. The other control circuits of the series production show a reduced lifetime of the first transistor and thus the reliability of the control circuit is diminished.

According to the known control circuit a solution for the said disadvantage is presented wherein a continuous feedback loop is applied for controlling the first transistor. The feedback loop controls the first transistor in such a way that the first transistor will be neither in an “over-steering” nor in an “under-steering” modus The feedback loop comprises an analogue-digital converter for generating a digital signal on the basis of the measured voltage on the base of the first transistor, a processing unit for generating a control signal on the basis of the digital signal, and a digital-analogue converter for generating an analogue control signal on the basis of the control signal. The thus generated analogue control signal is used for controlling the power supply. Subsequently, the power supply can control the resonance circuit, and the resonance circuit can drive the first transistor. In this way a continuously working closed control loop (feedback loop) is realised for driving the first transistor in an optimal way. This means that in principle each control circuit from a series production of control circuits, in spite of the spread of the relevant parameters of the control circuit, is controlled in an optimal way.

A disadvantage of the known control circuit is that the control circuit comprises a feedback loop which, in use, continuously adjusts the power supply. As a consequence, the load receives an electrical signal which is continuously fluctuating. In particular, in the case wherein the load is a deflection circuit of a CRT, this leads to a restless picture of the CRT. The continuously operating feedback loop is visible on the screen of the CRT. Another disadvantage of the known control circuit is that the control circuit is relatively expensive. A cause of this is the relatively expensive analogue to digital converter in the feedback loop of the control circuit.

It is an object of the invention to provide a control circuit which meets at least one of the said disadvantages. This is achieved by the control circuit according to the invention which is characterised in that the memory unit is arranged to be loaded with control information concerning predetermined states of the load and corresponding predetermined optimal control adjustments of the power supply and/or the pulse generating circuit, wherein the processing unit is/are arranged for optimally controlling the electrical signal by controlling the first transistor via the power supply and/or via the pulse generating circuit for an actual state of the load on the basis of the control information loaded in the memory unit. Herewith momentarily presented sync signals can be used for defining the actual state of the load.

With the control circuit according to the invention the power supply and/or the pulse generating circuit is controlled by the processing unit in dependence of the actual state of the load. There is no need for a closed control loop or feedback loop. The actual state of the load can be defined by, for example, a set of status-parameters. In the case that the load is a deflection circuit of a CRT, the set of status-parameters can comprise a parameter which indicates the desired line switching frequency and a parameter indicating the image size of the CRT. In operation the processing unit can establish the status-parameters indicating the actual state of the load, after which the processing unit can control the power supply and/or the pulse generating circuit for the actual state defined by the status-parameters on the basis of the control information loaded in the memory unit.

The memory unit can already be loaded with the said control information measured by factory measurement and control equipment in the factory. In this way, the control circuit disposes over control information for predetermined states of the load. The control information depends on relevant characteristics of the control circuit like the gain factor of the first transistor and transfer characteristics of other components of the control circuit. With the measured control information the first transistor can be controlled in an optimal way without the need of establishing all these characteristics of the control circuit in detail. Moreover, according to the invention, a control circuit is realised which provides a stable and reliable control of the electrical signal over the load. This is a consequence of the fact that the processing unit controls the power supply and/or the pulse generating circuit on the basis of control information relating to predetermined states of the load and not via a closed control loop or feedback loop. When a state of the load has been selected a stable control takes place and disturbances in the controlled electrical signal are minimal.

In particular, the control circuit according to the invention is suited for controlling a deflection circuit of a CRT, wherein an image can be generated in a very stable way and wherein no effects of the control of the power supply are visible on the generated image of the CRT. Furthermore, the control circuit according to the invention can be manufactured in a relatively cheap way since the control circuit does not have to be provided with an analogue to digital converter.

An embodiment of the control circuit according to the invention is characterized in that the pulse generating circuit is arranged for generating a pulse signal for switching the first transistor via the resonance circuit. The flanks or edges of the pulse signal define switching time-points of the first transistor. In this embodiment the power supply and the resonance circuit are controlled by the pulse signal for generating a switching signal which is fed to the first transistor. Thus, in this embodiment the first transistor is indirectly switched by the pulse generating circuit at time-points defined by the flanks of the pulse signal.

In an embodiment of the control circuit according to the invention the processing unit is coupled to the power supply for controlling the power supply. The processing unit can control the first transistor via the power supply and the resonance circuit.

In an embodiment of the control circuit according to the invention the processing unit is coupled to the pulse generating circuit for controlling the pulse generating circuit, wherein the pulse generating circuit is arranged for pulse-width modulation of the pulse signal. In this way the processing unit can control, via the pulse generating circuit, both the switching time points via de flanks of the pulse signal and the amplitude of the power supply via the pulse-width of the pulse signal.

A further embodiment of the control circuit according to the invention is characterized in that the pulse generating circuit comprises a second transistor, a pulse generator which is coupled to a basis and an emitter of the second transistor, and a transformer, wherein a first coil of the transformer is coupled to the power supply and a collector of the second transistor, and wherein a second coil of the transformer is coupled to the resonance circuit. Herewith, a possible resonance circuit is an LCR-circuit

A method according to the invention for adjusting a control circuit for controlling an electrical signal over a load according to the invention is characterised in that, the method at least comprises the steps of:

coupling the basis and the emitter of the first transistor with factory measurement and control equipment;

coupling the processing unit with factory measurement and control equipment;

adjusting the load in an actual state of the load, wherein the actual state of the load is one of the predetermined states of the load;

adjusting the power supply of the control circuit in a number of subsequent control adjustments of the power supply for the actual state of the load with the factory measurement and control equipment, wherein the factory measurement and control equipment adjusts the processing unit, and wherein the processing unit controls the power supply in a number of control adjustments of the power supply;

measuring voltage response characteristics with the basis and the emitter of the first transistor for each of the number of control adjustments of the power supply for the actual state of the load with the factory measurement and control equipment;

selecting an optimal control adjustment from the number of control adjustments of the power supply for the actual state of the load on the basis of the measured voltage response characteristics with the factory measurement and control equipment;

storing control information relating to the optimal control adjustment for the actual state of the load in the memory unit of the control circuit with the factory measurement and control equipment.

In case of an unprogrammed state of the load, the processing unit can determine the adjustment of the power supply according to an interpolation of two pre determined states which are close to the unprogrammed state which is used as a new state.

In the accompanying drawings, in which certain modes of carrying out the present invention are shown for illustrative purposes:

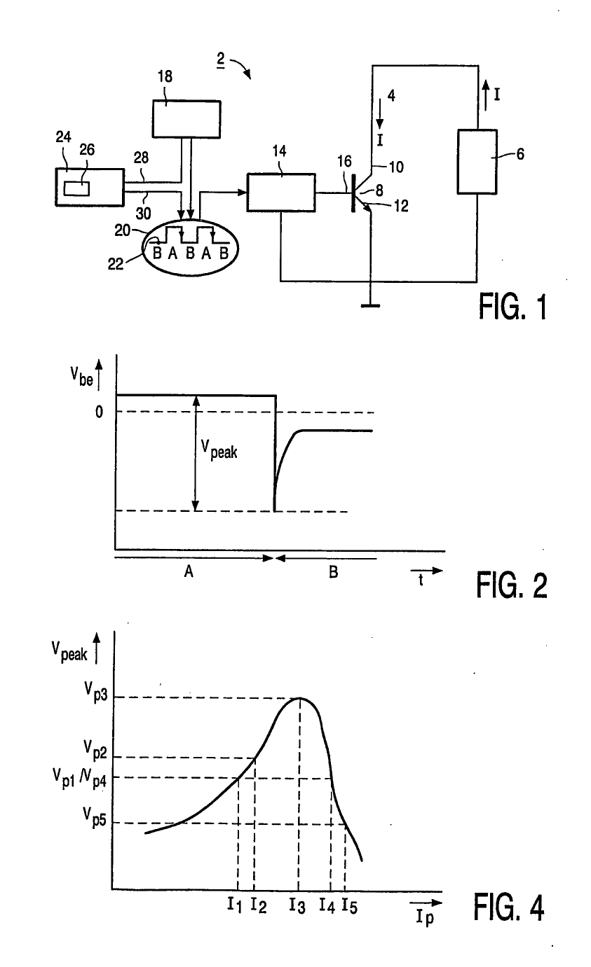

FIG. 1 schematically shows a part of a control circuit according to the invention;

FIG. 2 schematically shows a possible voltage response characteristic over the base and the emitter of the first transistor when the first transistor is switched off;

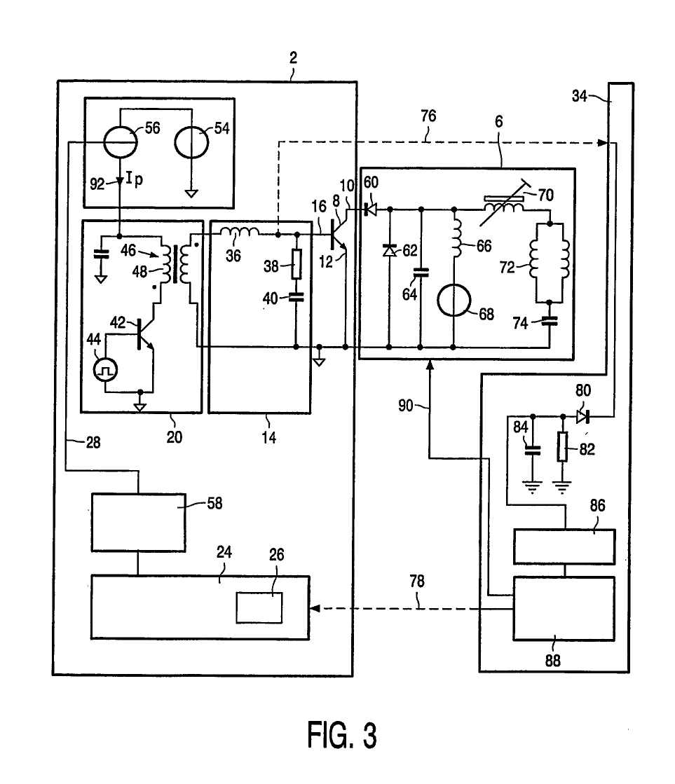

FIG. 3 schematically shows the control circuit according to the invention which is connected to factory measurement and control equipment;

FIG. 4 schematically illustrates how the factory measurement and control equipment can adjust the control circuits according to the invention for selecting optimal adjustment states for predetermined states of the load.

In FIG. 1 a part of the control circuit 2 according to the invention for controlling an electrical signal 4 over a load 6, such as a deflection circuit of a Cathode Ray Tube (CRT), is shown. In this case the electrical signal is a current I 4 through the collector 10 and the emitter 12 of the transistor 8. The control circuit comprises the first transistor 8 for switching the current I 4 over the load 6. The load 6 is connected with a collector 10 and an emitter 12 of the first transistor 8. The control circuit 2 also comprises a resonance circuit 14 which is connected with a basis 16 and the emitter 12 of the first transistor 8 for driving the first transistor 8. The power supply 18 is coupled via a pulse generating circuit 20 (thus indirectly connected) with the resonance circuit 14 for driving the resonance circuit 14. The pulse generating circuit 20 is, in the example of FIG. 1, also connected with a processing unit 24 which comprises a memory unit 26. The pulse generating circuit 20 can switch the first transistor 8 via a pulse signal 22 which is indicated schematically in FIG. 1. In this example the pulse signal 22 consists of a number of successive rectangular shaped pulses. The pulse signal 22 comprises alternating respective tops and downs corresponding with respective subsequent alternating time intervals A and B. At the transition of a top in the time interval A to a down in the time interval B there is a steep descending flank which is marked with an arrow in FIG. 1. It is at these flanks that the transistor 12 is switched off such that the current 4 is reduced to a value of about zero Ampere. The exact operation according to which the pulse generating circuit 20 switches the first transistor 8 is a complicated cooperation with the pulse generating circuit 20, the resonance circuit 14 and the power supply 18. This co-operation will not be described in detail in this patent application since it is known per se. The resonance circuit 14 can be a LCR-circuit, see for example FIG. 3.

The pulse generating circuit 20 generates a pulse signal 22 wherein during the time intervals. A the first transistor 8 is switched in a conducting state such that a maximal current I 4 flows through the collector 10 and the base 12 of the first transistor 8. Herewith there are three possible different situations.

In a first situation there is an “under-steering” of the first transistor 8. This means that the base-current into the base 16 of the first transistor 8 is to small to generate a negligible voltage over the collector 10 and the emitter 12. In this case even a small electrical current I 4 yields a considerable quantity of dissipated heat and thus a rapid increase of the temperature in the first transistor. Thus, in the case of “under-steering” there is a relatively large quantity of dissipated heat into the first transistor 8.

In a second possible situation of the first transistor 8 there is “over-steering”, which means that the base-current flowing into the base 16 of the first transistor 8 is larger than a value of the base-current following from the gain factor of the first transistor for generating the maximal electrical current I 4. At the transitions with the time intervals A to the time intervals B the base-current into the base 16 will reduce to zero. Subsequently in the second possible situation, the voltage at the base 16 can become zero or even negative, wherein the base-current can change sign such that the base-current is flowing out of the base 16 As a consequence of this the number of charge carriers into the base 16 of the first transistor 8 will diminish rapidly and will become zero. Diminishing the number of charge carriers in the base 16 will cause a reduction of the electrical current I 4, while the voltage over the collector and the emitter of the first transistor 8 rises as a consequence of the behaviour of the inductive load 6. During the rise and fall of the corresponding electrical current I 4 through the collector 10 and the emitter 12 a power peak is created which will be dissipated into the first transistor 8. This has the consequence that a relatively large heat dissipation will take place into the first transistor 8.

In a third situation the transistor 8 is driven between the “under-steering” and the “over-steering” state of the first transistor 8. In the third situation the transistor 8 is driven in an optimal way. This is called the optimal drive of the first transistor 8, wherein the heat dissipation into the first transistor is minimal. This optimal control of the first transistor 8 is the situation wherein the electrical voltage of the base 16 of the first transistor 8 has a maximal (negative) peak voltage Vp over the base 16.

It is a task of the processing unit 24, which is loaded with control information comprising optimal control adjustments of the control circuit 2 for controlling the control circuit 2 in such a way that the first transistor 8 is controlled with optimal drive with an optimal control adjustment.

When the transistor 8 is shut off by the pulse generating circuit 20 by means of the pulse signal 22, the base-current into the base 16 of the first transistor will be a negative electrical current (thus flowing out of the base 16 of the transistor 8) which will rise in a short time to a value of about zero. The thus generated base-current out of the base 16 flows into the resonance circuit 14. The resonance circuit 14 can comprise an LCR-circuit. This results in an voltage response characteristic V_{BE} which is schematically indicated as a function of t (time) in FIG. 2 The magnitude of this voltage response characteristic is dependent of the speed with which the base-current in the base 16 of the first transistor 8 rises and of the magnitude of the current I 4. Herewith the reached voltage peak Vp will be maximal if there is no “over-steering” and no “under-steering” of the first transistor 8. Consequently, the reached value peak is an indication for the optimal control of the first transistor 8.

The control circuit 2 comprises a processing unit 24 with a memory unit 26, wherein the memory unit 26 is loaded with control information. The control information concerns predetermined states of the load 6 and corresponding predetermined optimal control adjustments of the control circuit 2. The processing unit 24 is arranged for optimally controlling the power supply 18 for an actual state of the load 6 on the basis of the control information. For this the processing unit 24 can be connected directly via a connection 28 with the power supply, but alternatively the processing unit can also only be connected via a connection 30 with the pulse generating circuit 20. In the latter case the processing unit 24 can control the power supply 18 in an indirect way by pulse width modulation of the pulse signal 22. In either way the pulse generating circuit 20 generates a pulse signal 20 of which the flanks define the switching time points of the first transistor 8. For this operation the pulse generating circuit 20 is connected with the first transistor 8 via the resonance circuit 14.

It is important to note that the control circuit 2 can control the electrical signal 4 over the load depending on the actual state of the load 6. If the load 6 is the deflection coil of a CRT, the predetermined states are defined by a set of status-parameters. Such a set of status parameters can define for example a line switching frequency in the interval of 30-120 KHz, different image sizes, etc. Each predetermined state of the load requires different electrical signals 4 and corresponding different base-currents at the base 16 of the first transistor 8. The optimal values are those values for which the first transistor 8 dissipates as few as possible electrical energy. The optimal control adjustment, wherein the heat dissipation of the first transistor 8 is minimal, is achieved at the point wherein the peak voltage Vp is maximal.

As will be explained later on, with the help of FIG. 3, these optimal control adjustments can already be established in the factory by factory measurement and control equipment. The optimal control adjustments are established and subsequently stored into the memory unit 26 of the processing unit 24.

FIG. 3 shows in details an embodiment of the control circuit 2 according to the invention, which is both connected with a load 6 comprising a deflection circuit and factory measurement and control equipment 34.

The control circuit 2 comprises a first transistor 8 for switching an electrical signal I 4 over the load 6 The load 6 is connected with a collector 10 and an emitter 12 of the first transistor 8. The control circuit 2 also comprises a resonance circuit 14 comprising an LCR-circuit. The LCR-circuit consists of an inductive reactance 36 such as a coil, a resistance 38, and a capacitance of the blocked basis-emitter junction of the first transistor 8.

The resonance circuit 14 is connected with the pulse generating circuit 20 which comprises a second transistor 42, a pulse generator 44 which is connected with a base and an emitter of the second transistor 42, and a transformer 46. A first coil 48 of the transformer 46 is connected with the power supply 18 and a collector of the second transistor 42. Furthermore, a second coil 50 of the transformer 46 is connected with the resonance circuit 14. Finally, the pulse generating circuit 20 comprises a coupling capacitor 52 which is connected with earth and a junction which is connected both with the first coil 46 and the power supply 18.

The power supply 18 in this example comprises a base driver 54 for generating a supply voltage 54 which is connected with earth and a voltage controlled current source 56.

The voltage controlled current source 56 is connected with the said junction and a digital to analogue converter 58. The digital to analogue converter 58 is the interface with the processing unit 24 and the power supply voltage 18. In this example the processing unit 24 is a microprocessor which comprises the memory unit 26.

The load 6 comprises a deflection circuit which is schematically indicated in FIG. 3. The load 6 comprises a collector series diode 60 which is connected with collector 10 of the first transistor 8 and other components of the load 6. These other components are the fly back diode 62, the fly back capacitor 64, the supply coupling coil 66 which is connected in series with the deflection supply voltage 68, and the linearity corrector 70 which is connected in series with a parallel connection of deflection coils 72 and a DC-blocking capacitor 74. The deflection circuit of the load 6 in the FIG. 3 is known per se and will not be discussed in detail. An important thing to note here is that the deflection circuit can be in different states depending on state parameters such as different switching frequencies for line deflection and different image formats displayed on the screen of the CRT.

In the example of FIG. 3 the control circuit 2 is connected with the factory measurement and control equipment 34 via the connections 76 and 78. The factory measurement and control equipment 34 comprises a peak rectifier diode 80 which is connected in series with a parallel connection of a discharge resistor 82 for setting the time constant of the peak voltage rectifier and a storage capacitor 84 for rectifying the peak voltage Vpeak measured via the connection 76 at the base 16 of the first transistor 8. The peak rectifier diode 80, the discharge resistor 82 and the storage capacitor 84 are connected with an analogue to digital converter 86. The analogue to digital converter 86 is connected with a measurement and control processing unit 88 of the measurement and control equipment 34. The measurement and control processing unit 88 is connected via a connection 78 with the processing unit 24 of the control circuit 2.

Hereinafter the method for adjusting the control circuit 2 with the factory measurement and control equipment 34 is explained in detail.

At the factory the control circuit 2 can be connected via the connections 76, 78 with the factory measurement and control equipment 34. Then a measurement and adjustment cycle is started wherein the factory measurement and control equipment 34 is also connected with the load 6 via a control connection 90. Subsequently, the load 6 is adjusted into one of its predetermined states. In this predetermined state the measurement and control processing unit 88 controls the processing unit 24 via the connection 78 such that the processing unit 24 controls the power supply 18 in a first control adjustment. Herewith, the pulse generating circuit 20 drives the resonance circuit 14 for driving the first switching transistor 8, wherein the flanks of the pulse signal define the switching time points. Then, the actual voltage over the base 16 and the emitter 12 is measured by the factory measurement and control equipment 34 via the connection 76. An example of a measured voltage V_{BE} over the base 16 and emitter 12 is shown in FIG. 2. The function V_{BE} is the voltage response characteristic. As is shown in FIG. 2 in a time interval. A the voltage over the base and the emitter of the first transistor is essentially a constant value. Then, at the transition of the time interval A to the time interval B, the voltage V_{BE} drops with the peak voltage Vpeak wherein the voltage V_{BE} can become negative and subsequently rises to a zero or negative value. The value Vpeak is an important parameter for determining the optimal control adjustment of the control circuit 2 and in particular for an optimal drive or steering of the first transistor 8. The factory measurement and control equipment 34 will measure the peak voltage Vp for different control adjustments of the power supply 18 in the predetermined state of the load 6. Afterwards, the optimal control adjustment for the predetermined state is found by selecting that particular voltage response characteristic V_{BE} wherein Vp is maximal This procedure is schematically indicated in FIG. 4. Along the vertical axis of the coordinate system of FIG. 4 the value Vₚₑₐₖ is measured and along the horizontal axis the current Iₚ 92 which is generated by the voltage current source 56 is measured. In a first adjustment, which is made by the factory measurement and control equipment 34, the voltage controlled current source 56 drives an electrical current Iₚ into the pulse generating circuit 20. Then as a response the peak voltage Vₚₑₐₖ=Vp1 is measured and stored by the factory measurement and control equipment 34. Then, in a second adjustment an electrical current Iₚ 92 is generated with a corresponding peak voltage Vₚ₂. This procedure is continued until the maximal possible peak voltage Vₚ₃ is found for the optimal control adjustment I₃. It is this optimum control adjustment which is stored by the factory measurement and control equipment 34, via the connection 78, into the memory unit 26 of the processing unit 24. Preferably the memory unit 26 is an EEPROM unit for storing information.

Subsequently, the factory measurement and control equipment 34 performs the procedure described in the preceding paragraph for other predetermined states of the load 6. In this way for each predetermined state of the load an optimal control adjustment is found which can be stored into the memory unit 26 of the processing unit 24.

After the factory measurement and control equipment 34 has established the optimal control adjustments for the predetermined states of the load 6, the connections 76,78, 90 are disconnected, after which the control unit and the load 6 are ready for trade. The combination of the control circuit 2 and the load 6 is able to operate in an optimal way, wherein for each predetermined state of the load 6 the control circuit is capable of driving the first transistor 8 in an optimal way. This is done by a control sequence which does not comprise a feedback loop. The control sequence in this case comprises the processing unit 24, the digital to analogue converter 58, the power supply 18, the pulse generating circuit 20, and the resonance circuit 14 which is connected with the first transistor 8. Since there is no feedback loop in this control sequence, a very stable and reliable optimal control of the first transistor 8 is realised. Consequently the first transistor 8 will show a minimal heat dissipation, such that combination control circuit 2 plus load 6 can perform optimally.

The invention is described according to a few embodiments. The invention however is by no means limited to these embodiments. Modifications and variations of the described embodiments are also considered to fall within the scope of this invention. Furthermore, a wide scope of applications of the control circuit according to the invention are possible. For example, the control circuit according can be used in switch mode power supplies, lamp driver circuits and motor control circuits.

1. Control circuit for controlling an electrical signal over a load such as a deflection circuit of a Cathode Ray Tube, comprising a first transistor for switching the electrical signal over the load, wherein the load is coupled to a collector and an emitter of the first transistor, and wherein the control circuit also comprises a resonance circuit which is coupled to a basis and the emitter of the first transistor for driving the first transistor, a power supply which is coupled to the resonance circuit for driving the resonance circuit, a pulse generating circuit which is coupled to the power supply and the resonance circuit, and a processing unit with a memory unit , characterised in that, the memory unit is arranged to be loaded with control information concerning predetermined states of the load and corresponding predetermined optimal control adjustments of the power supply and/or the pulse generating circuit, wherein the processing unit is arranged for optimally controlling the electrical signal by controlling the first transistor via the power supply and/or via the pulse generating circuit for an actual state of the load on the basis of the control information loaded in the memory unit.

2. Control circuit for controlling an electrical signal over a load according to claim 1, characterised in that, the pulse generating circuit is arranged for generating a pulse signal for switching the first transistor via the resonance circuit.

3. Control circuit for controlling an electrical signal over a load according to claim 1, characterised in that, the processing unit is coupled to the power supply for controlling the power supply.

4. Control circuit for controlling an electrical signal over a load according to claim 1, characterised in that the processing unit is coupled to the pulse generating circuit for controlling the pulse generating circuit, wherein the pulse generating circuit is arranged for pulse-width modulation of the pulse signal.

5. Control circuit for controlling an electrical signal over a load according to claim 1, characterised in that, the pulse generating circuit comprises a second transistor, a pulse generator which is coupled to a basis and an emitter of the second transistors, and a transformer, wherein a first coil of the transformer is coupled to the power supply and a collector of the second transistors, and wherein a second coil of the transformer is coupled to the resonance circuit.

6. Control circuit for controlling an electrical signal over a load according to claim 1, characterised in that, the resonance circuit is an LCR-circuit.

7. Control circuit for controlling an electrical signal over a load according to claim 1, characterised in that, the processing unit is a microprocessor and that the memory unit is a digital EEPROM.

8. Method for adjusting a control circuit for controlling an electrical signal over a load according to claim 1, characterised in that, the method at least comprises the steps of:
coupling the basis and the emitter of the first transistor with factory measurement and control equipment;
coupling the processing unit with factory measurement and control equipment;
adjusting the load in an actual state of the load, wherein the actual state of the load is one of the predetermined states of the load;
adjusting the power supply of the control circuit in a number of subsequent control adjustments of the power supply for the actual state of the load with the factory measurement and control equipment, wherein the factory measurement and control equipment adjusts the processing unit, and wherein the processing unit controls the power supply in a number of control adjustments of the power supply;
measuring voltage response characteristics with the basis and the emitter of the first transistor for each of the number of control adjustments of the power supply for the actual state of the load with the factory measurement and control equipment;
selecting an optimal control adjustment from the number of control adjustments of the power supply for the actual state of the load on the basis of the measured voltage response characteristics with the factory measurement and control equipment;
storing control information relating to the optimal control adjustment for the actual state of the load in the memory unit of the control circuit with the factory measurement and control equipment.
